(19) United States
(12) Patent Application Publication
(10) Pub. No.: US 2019/0156074 A1
(43) Pub. Date: May 23, 2019

(54) RFID Reader and Method for Anti-Collision in a Multi-Tag RFID System

(71) Applicant: IMEC Taiwan Co., Hsinchu (TW)

(72) Inventor: Tao Lee, Taichung City (TW)

(21) Appl. No.: 16/193,275

(22) Filed: Nov. 16, 2018

(30) Foreign Application Priority Data
Nov. 23, 2017 (TW) 106140778

(51) Int. Cl. G06K 7/10

(52) U.S. Cl. CPC G06K 7/10019; G06K 7/10366; G06K 7/10316

(57) ABSTRACT

Example embodiments relate to radio frequency identification (RFID) readers and methods for anti-collision in multi-tag RFID systems. One embodiment includes a RFID reader. The RFID reader includes an antenna module configured to scan a plurality of tags. Each of the plurality of tags has a unique identifier (UID) and includes information on an object to which the tag is attached. The RFID reader also includes a control module configured to activate the antenna module to identify the plurality of tags and, in response to a collision event, send a select command with a select condition to identify a specific tag.

### CROSS-REFERENCE TO RELATED APPLICATIONS

The present application is a non-provisional patent application claiming priority to Taiwanese Patent Application No. TW 106140778, filed Nov. 23, 2017, the contents of which are hereby incorporated by reference.

### BACKGROUND

Radio frequency identification (RFID) has become more and more popular in various applications such as supply chain management and distribution. Despite extensive research and development in RFID technology, RFID tags collision problems remain a serious issue. Tag collision in an RFID system happens when multiple tags are energized by an RFID reader simultaneously, and reflect their respective signals back to the RFID reader at the same time. This problem is often seen whenever a large volume of tags is read together in the same RF field. The RFID reader is unable to differentiate these signals. Consequently, tag collision confuses the RFID reader.

It may therefore be desirable to have a method of anti-collision in a multi-tag RFID system. It may also be desirable to provide an RFID reader with anti-collision ability in a multi-tag RFID system.

### SUMMARY

The present disclosure is directed to an RFID reader and a method for anti-collision of tags.

Embodiments provide a radio frequency identification (RFID) reader. The RFID reader includes an antenna module configured to scan a plurality of tags, each of the tags having a unique identifier (UID) and including information on an object to which the each tag is attached, and a control module configured to activate the antenna to identify the plurality of tags and, in response to a collision event, send a select command with a select condition to identify a specific tag.

In an embodiment, the antenna module is disposed in a board having one of an oval shape, a circular shape, and a rectangular shape.

In another embodiment, the control module is configured to activate the antenna module in response to a command from a host, and send to the host a report including information on the number of tags and UIDs of the tags.

In yet another embodiment, the control module is electrically coupled with the host via a hub.

In still another embodiment, each of the tags includes a memory configured to store object-related information.

In yet still another embodiment, the control module is configured to generate a first select command with a first select condition to identify a first tag in a collision event, and generate a second select command with a second select condition to identify a second tag that collides with the first tag in the collision event.

In still yet another embodiment, the first select condition and the second select condition include information on a predetermined bit of UIDs of the first tag and the second tag.

Some embodiments provide a multi-reader system. The multi-reader system includes a plurality of RFID readers and a host electrically coupled with the plurality of RFID readers. Each of the RFID readers includes an antenna module configured to scan a plurality of tags, each of the tags having a unique identifier (UID) and including information on an object to which the each tag is attached, and a control module configured to activate the antenna to identify the plurality of tags and, in response to a collision event, send a select command with a select condition to identify a specific tag. The host is configured to activate at least one of the RFID readers and store information on objects to which the tags are attached.

In an embodiment, the control module is configured to generate a first select command with a first select condition to identify a first tag in a collision event, and generate a second select command with a second select condition to identify a second tag that collides with the first tag in the collision event.

In another embodiment, the first select condition and the second select condition include information on a predetermined bit of UIDs of the first tag and the second tag.

In yet another embodiment, the host includes a database that stores information on at least one of a duration time of a pick-up event and attributes of a customer associated with a pick-up event.

In still another embodiment, the multi-reader system further includes a display electrically coupled with the host and configured to play a commercial material associated with an object in response to a pickup event of the object.

In yet still another embodiment, the host is configured to determine whether the commercial material is attractive based on the information in the database.

In still yet another embodiment, the host is configured to activate the plurality of readers in a sequential order.

In a further embodiment, the host is configured to activate the plurality of readers in parallel.

Embodiments also provide a method of anti-collision of tags. The method includes activating a plurality of tags, obtaining UIDs of the plurality of tags, identifying that a collision event between a first tag and a second tag of the plurality of tags, sending a first select command with a first select condition to identify the first tag, and sending a second select command with a second select condition to identify the second tag.

In an embodiment, the first select condition and the second select condition include information on a predetermined bit of the UIDs of the first tag and the second tag.

The foregoing has outlined rather broadly the features of example embodiments in order that the detailed description that follows may be better understood. Additional features of example embodiments will be described hereinafter, and form the subject of the claims. It should be appreciated by those skilled in the art that the conception and specific embodiment disclosed might be readily utilized as a basis for modifying or designing other structures or processes for carrying out the same purposes. It should also be realized by those skilled in the art that such equivalent constructions do not depart from the spirit and scope of the invention as set forth in the appended claims.

### BRIEF DESCRIPTION OF THE DRAWINGS

The objectives of example embodiments will become apparent upon reading the following description and upon reference to the accompanying drawings.

FIG. 1A is a top view of an RFID reader, according to example embodiments.

FIG. 1B is a side view of the RFID reader illustrated in FIG. 1A, according to example embodiments.

FIG. 1C is a side view of the RFID reader illustrated in FIG. 1A, according to example embodiments.

FIG. 2A is a diagram of an RFID reader with associated antenna module, according to example embodiments.

FIG. 2B is a diagram of an RFID reader with associated antenna module, according to example embodiments.

FIG. 2C is a diagram of an RFID reader with associated antenna module, according to example embodiments.

FIG. 3A is a flow diagram showing a scanning operation of an RFID reader, according to example embodiments.

FIG. 3B is a flow diagram showing an access operation of an RFID reader, according to example embodiments.

FIG. 4 is a schematic diagram of a binary search tree, according to example embodiments.

FIG. 5 is a schematic diagram showing a method of anti-collision, according to example embodiments.

FIG. 6 is a flow diagram showing a method of building a binary search tree under a collision event, according to example embodiments.

FIG. 7 is a diagram of a multi-reader system including a plurality of RFID readers, according to example embodiments.

FIG. 8A is a schematic diagram of a sequential scheduling mechanism for the multi-reader system illustrated in FIG. 7, according to example embodiments.

FIG. 8B is a schematic diagram of a parallel scheduling mechanism for the multi-reader system illustrated in FIG. 7, according to example embodiments.

FIG. 9 is a flow diagram showing a method of determining a scheduling mechanism for the multi-reader system illustrated in FIG. 7, according to example embodiments.

FIG. 10 is a diagram showing a method of inventory management in a system that includes one or more RFID readers, according to example embodiments.

FIG. 11 is a diagram showing a method of inventory management in a system that includes one or more RFID readers, according to example embodiments.

FIG. 12 is a diagram showing a method of inventory management in a system that includes one or more RFID readers, according to example embodiments.

FIG. 13A is a diagram of a system for advertisement management based on one or more RFID readers, according to example embodiments.

FIG. 13B is a diagram of a system for advertisement management based on one or more RFID readers, according to example embodiments.

FIG. 14 is a diagram showing a method of advertisement management in a system that includes one or more RFID readers, according to example embodiments.

### DETAILED DESCRIPTION

The embodiments are shown in the following description with the drawings, wherein similar or same components are indicated by similar reference numbers.

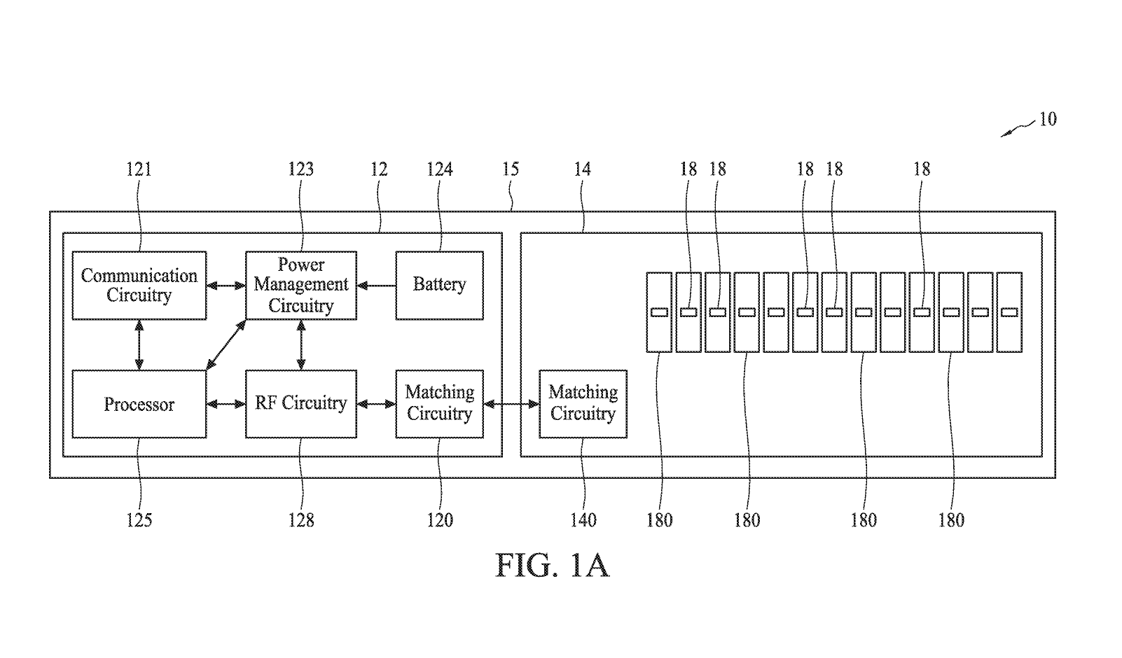

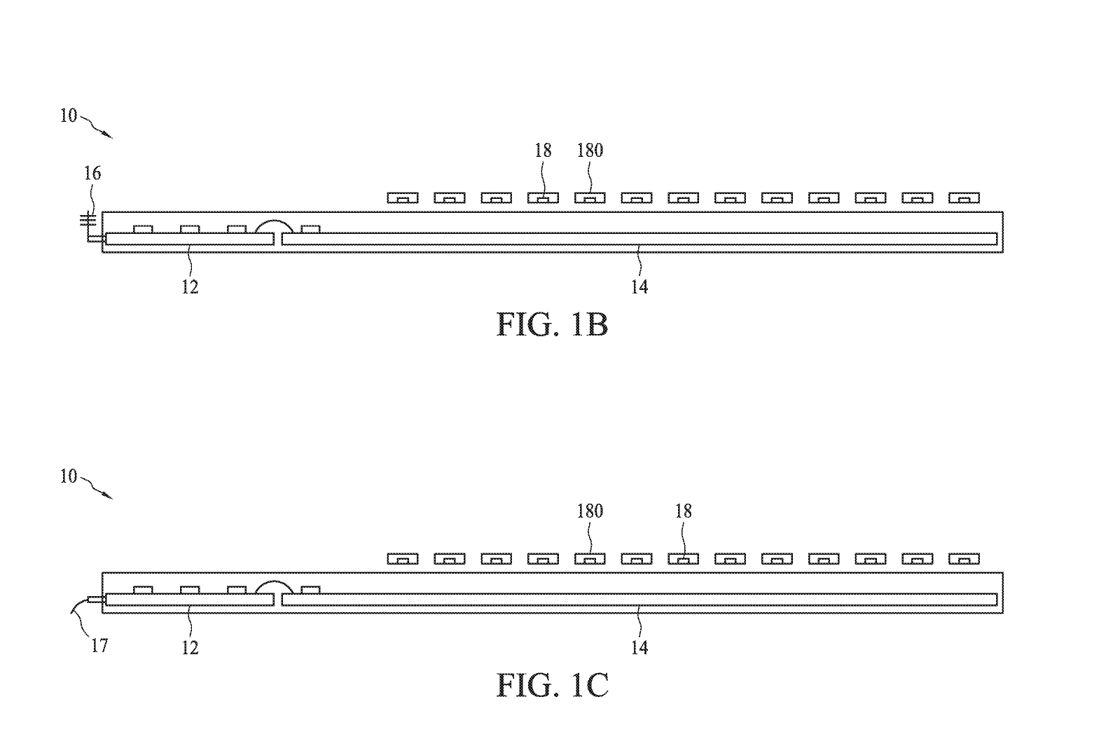

FIG. 1A is a top view of a radio frequency identification (RFID) reader 10, in accordance with some embodiments.

Referring to FIG. 1A, the RFID reader 10 includes a control module 12 and an antenna module 14, which are enclosed in a housing 15. The antenna module 14 is configured to build an electric field between the antenna module 14 and a plurality of tags 18 (only some of them are labeled) arranged over the antenna module 14 so that the control module 12 can identify tags 18 within an effective distance in the electric field. In an embodiment, the control module 12 communicates with the tags 18 in accordance with a near-field communication protocol. In that case, the tags 18 may be disposed at a distance of approximately 3 to 5 centimeters from the antenna module 14. Each of the tags 18 is attached to an object 180, and has a unique identifier (UID). A tag 18 may also contain object-related information such as a stock number, lot or batch number, production date, or other specific information. The object 180 is a commercial product, which may include a pack of cigarette, a smartphone, a pen, etc.

The control module 12 is configured to activate the antenna module 14 and, when the electric field is established, obtains product IDs of objects. Since each object has a unique product ID, the control module 12 can identify a specific object based on the information in a tag 18 corresponding to the specific object. The control module 12 includes a communication circuitry 121, a power management circuitry 123, a battery 124, a processor 125, an RF circuitry 128 and a matching circuitry 120. The communication circuitry 121 serves as an input/output (I/O) port for communication with a host such as a server or computing device. The power management circuitry 123 monitors the power of the battery 124. The RF circuitry 128, under the control of the processor 125, excites an RF signal which causes the antennal module 14 to build an electric field through the matching circuitry 120 in the control module 12 and another matching circuitry 140 in the antenna module 14.

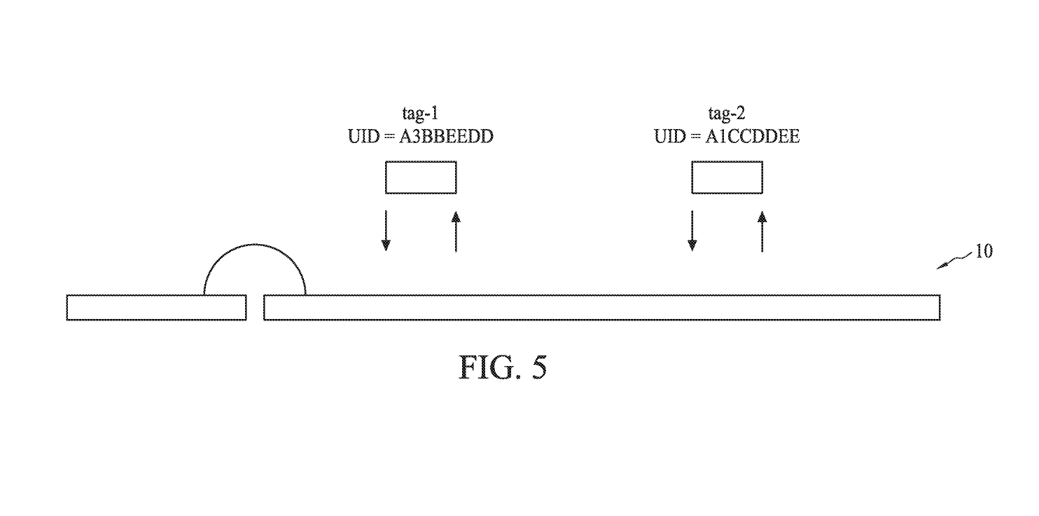

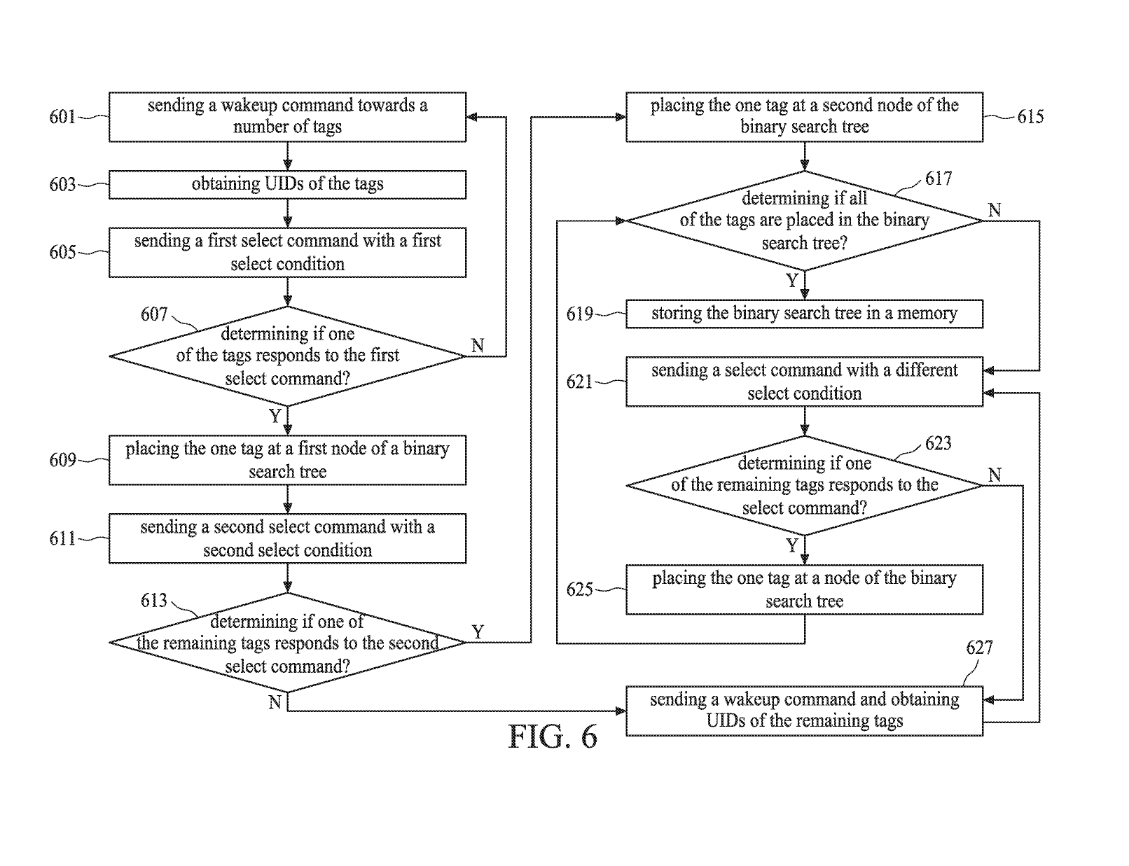

The processor 125 is configured to communicate with a host, and coordinate operations among the communication circuitry 121, power management circuitry 123, RF circuitry 128 and matching circuitry 120. In addition, the processor 125 is configured to identify the tags in an anti-collision mechanism, as will be further discussed in detail with reference to FIGS. 5A, 5B, and 6.

FIG. 1B is a side view of the RFID reader 10 illustrated in FIG. 1A, in accordance with an embodiment. Referring to FIG. 1B, the control module 12 may wirelessly communicate with a host through an antenna 16.

FIG. 1C is a side view of the RFID reader 10 illustrated in FIG. 1A, in accordance with another embodiment. Referring to FIG. 1C, the control module 12 may communicate with a host through a cable 17 in a wired manner.

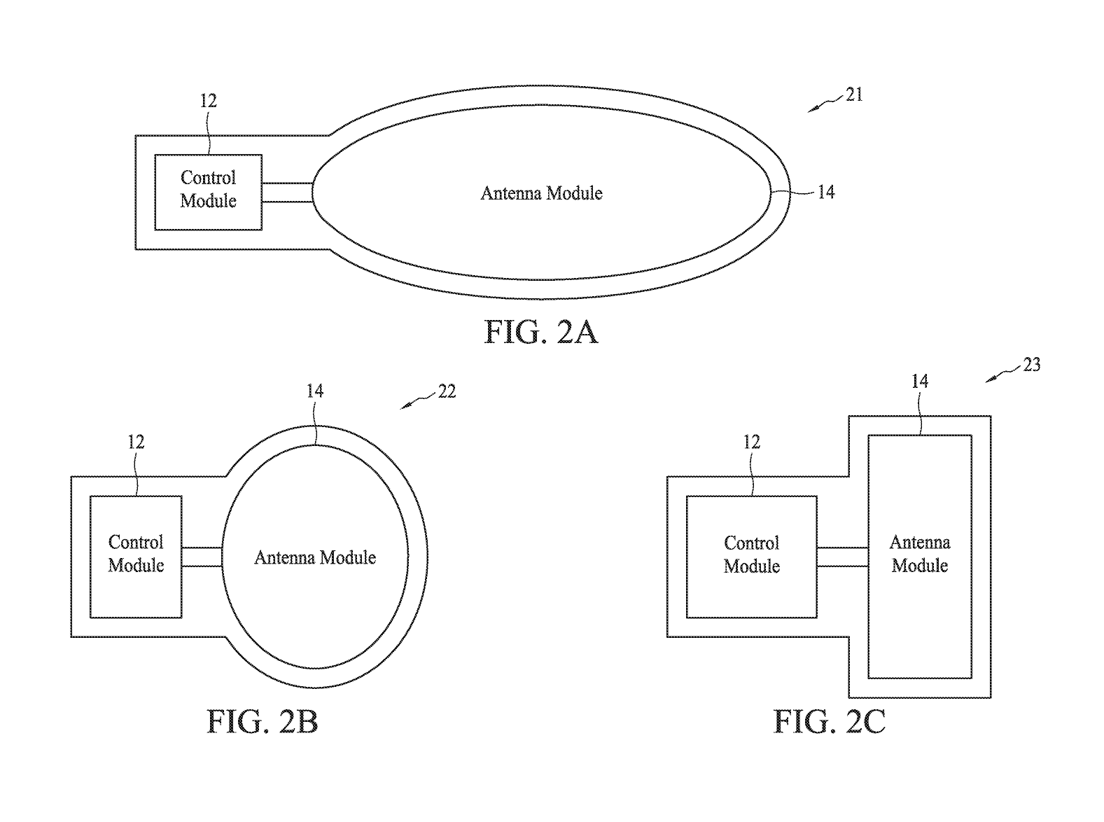

FIGS. 2A, 2B, and 2C are diagrams of RFID readers 21, 22 and 23 having different shapes of antenna modules, in accordance with some embodiments. Referring to FIG. 2A, the RFID reader 21 includes an antenna module having an oval shape. Referring to FIG. 2B, the RFID reader 22 includes an antenna module having a circular shape. Referring to FIG. 2C, the RFID reader 23 includes an antenna module having a rectangular shape.

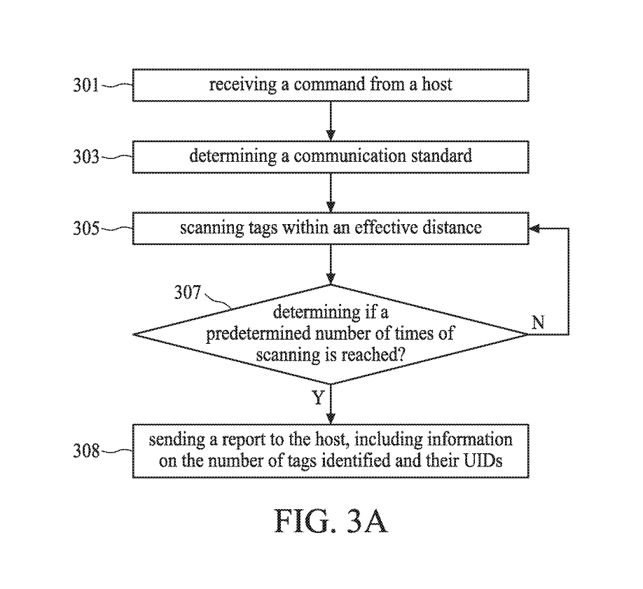

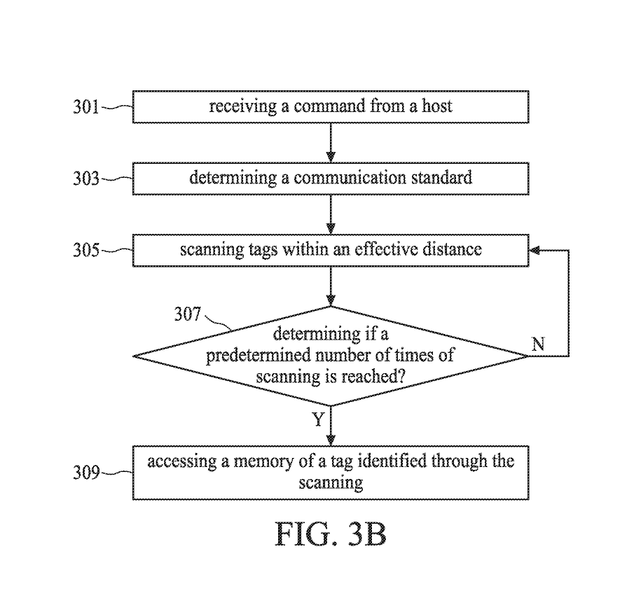

FIG. 3A is a flow diagram showing a scanning operation of an RFID reader, in accordance with some embodiments.

Referring to FIG. 3A, in operation 301, a command from a host is received by the RFID reader. The command may include an “ON” command, an “OFF” command” or a “SCAN” command. In response to the ON command, the RFID reader activates its antenna module for a scanning operation. In response to the OFF command, no scanning operation is performed. In response to the SCAN command, the RFID reader activates its antenna module for a scanning operation on a predetermined time interval.

In operation 303, a communication standard is determined for scanning operation. The communication standard may include but is not limited to the international organization for standardization (ISO) 14443A, ISO 14443B, and ISO 15693. The ISO 14443A and ISO 14443B standards support proximity contactless cards, while the ISO 15693 standard supports vicinity contactless cards.

In operation 305, tags within an effective distance from the antenna module of the RFID reader are scanned. In an embodiment, the effective distance is approximately 3 to 5 centimeters between the tags and the antenna module. The tags may be scanned once or several times in operation 307 until a predetermined number of times of scanning is reached. The multiple scanning ensures a more reliable count of the number of tags detected. For example, in the case of one-time scanning, an object may be taken by a consumer immediately after the scanning. As a result, a report on the number of tags to the host may not reflect the real-time correct number until a next round of scanning.

In operation 308, a report is sent to the host. The report includes information on the number of tags identified and their UIDs.

FIG. 3B is a flow diagram showing an access operation of an RFID reader, in accordance with some embodiments.

As previously discussed, a tag 18 may include object-related information in addition to a UID. Such information may be stored in a memory of the tag 18. The memory is accessible during a reading or a writing operation, as shown in operation 309 of FIG. 3B.

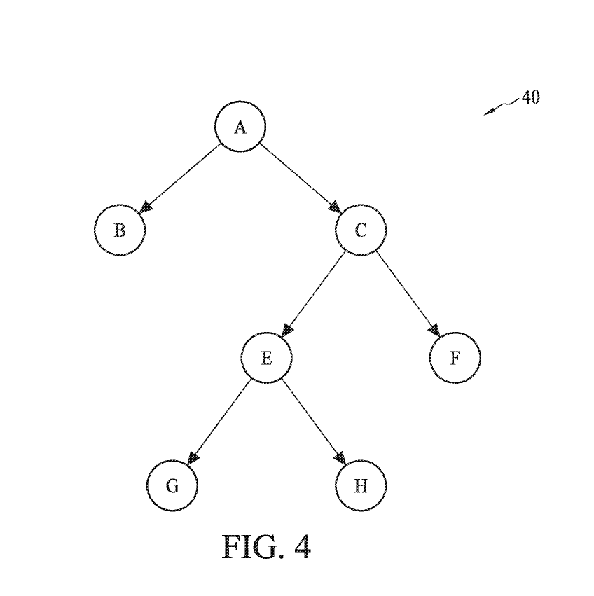

FIG. 4 is a schematic diagram of an example binary search tree 40.

The RFID reader 10 transmits an encoded radio signal to interrogate the tags 18. The tags 18 receive the message and then respond their UIDs and object-related information. Since the UIDs of the tags 18 are different from one another, the RFID reader 10 can discriminate among the tags 18 within the range of the RFID reader 10 and read them simultaneously. Tags 18 identified by the RFID reader 10 are placed in a predetermined order as nodes in the binary search tree 40. In a binary search tree, every node can have maximum of two children. Moreover, the tags 18 are arranged as they arrive to the tree, from top to bottom and left to right. Referring to FIG. 4, a tag 18 first identified is placed at node A, the root node, and tags subsequently identified are placed in an order at nodes B, C, E, F, G, and H, or in another order at nodes B, C, E, G, H, and F.

FIG. 5 is a schematic diagram showing a method of anti-collision, in accordance with some embodiments.

In a multi-tag RFID system, several tags may reflect signals back to an RFID reader in the exact same time frame, causing data confusion and incorrect identification. Referring to FIG. 5 tag collision happens when a first tag (tag-1) and a second tag (tag-2) respond to the RFID reader 10 simultaneously. The RFID reader 10 has obtained the UIDs, in the present example A3BBEEDD and A1CCEEDD, associated with the first tag and the second tag, but cannot determine to which the UIDs belong. To discriminate between the first tag and the second tag, the RFID reader 10 sends a first select command with a first select condition towards the first tag and the second tag, respecting that only one of the first tag and the second tag will respond. If, for example, the first tag responds, then the first tag is confirmed and placed at a first node of the binary search tree 40. Moreover, the RFID reader 10 sends a second select command with a second select condition towards the first tag and the second tag, respecting that only the other one of the first tag and the second tag will respond. If the second tag responds, then the second tag is confirmed and placed at a second node of the binary search tree 40.

In some embodiments, the first select condition and the second select condition request a tag with a predetermined value at a predetermined bit of its UID to respond. For example, for the first select condition, the RFID reader 10 requests a tag with a value of one (1) at the second least significant bit of the first byte in its UID to respond. Moreover, for the second select condition, the RFID reader 10 requests a tag with a value of zero (0) at the second least significant bit of the first byte in its UID to respond. Since the first bytes of the UIDs A3BBEEDD and A1CCEEDD are A3 (=10100011 in binary) and A1 (=10100001 in binary), respectively, and further since that the second least significant bits of the above-mentioned first bytes are 1 and 0, respectively, assuming that the UID of the first tag is A3BBEEDD while the UID of the second tag is A1CCEEDD, the first tag will respond to the first select command with the first select condition, while the second tag will respond to the second command with the second select condition.

Although for convenience an anti-collision method for collision between two tags is discussed, the anti-collision method is still applicable to process collision among three or more tags.

Referring back to FIG. 1, the processor 125 of the RFID reader 10 may be configured to send a select command with select condition towards tags 18 in response to a collision. The select condition specifies a predetermined value at a predetermined bit in UIDs of collision-involved tags.

FIG. 6 is a flow diagram showing a method of building a binary search tree under a collision event, in accordance with some embodiments.

Referring to FIG. 6, in operation 601, a wakeup command to activate an antenna module is sent from an RFID reader towards a number of tags. Subsequently, the UIDs associated with the tags are obtained in operation 603.

In operation 605, in response to a collision event, a first select command with a first select condition is sent. If one of the tags responds to the first select command in operation 607, the one tag satisfying the first select condition is confirmed and placed at a first node of the binary search tree in operation 609. If none of the tags responds in operation 607, then the operations 601, 603, and 605 are repeated.

In operation 611, a second select command with a second select condition is sent. If one of the remaining tags responds to the second select command in operation 613, the one tag satisfying the second select condition is confirmed and placed at a second node of the binary search tree in operation 615. Next, in operation 617, it is determined if all of the tags are placed in the binary search tree. If confirmative, the binary search tree is stored in a memory in operation 619. If not, which means that the collision event still exists, a select command with a different select condition is sent in operation 621. It is then determined in operation 623 if one of the remaining tags responds to the different select command, which may be a third select command with a third select condition. If confirmative, the one tag satisfying the different select condition is confirmed and placed at a node such as a third node of the binary search tree in operation 625. Subsequently, the operation 617 is repeated to check if the collision event still exists.

If in operation 613 none of the remaining tags responds, then in operation 627, similar to operations of 601 and 603, a wakeup command is sent and the UIDs of the remaining tags are obtained. Then in operation 621, a select command with a different select condition from the first select condition is sent.

In addition, if in operation 623 none of the remaining tags responds, the operations 627 and 621 are repeated.

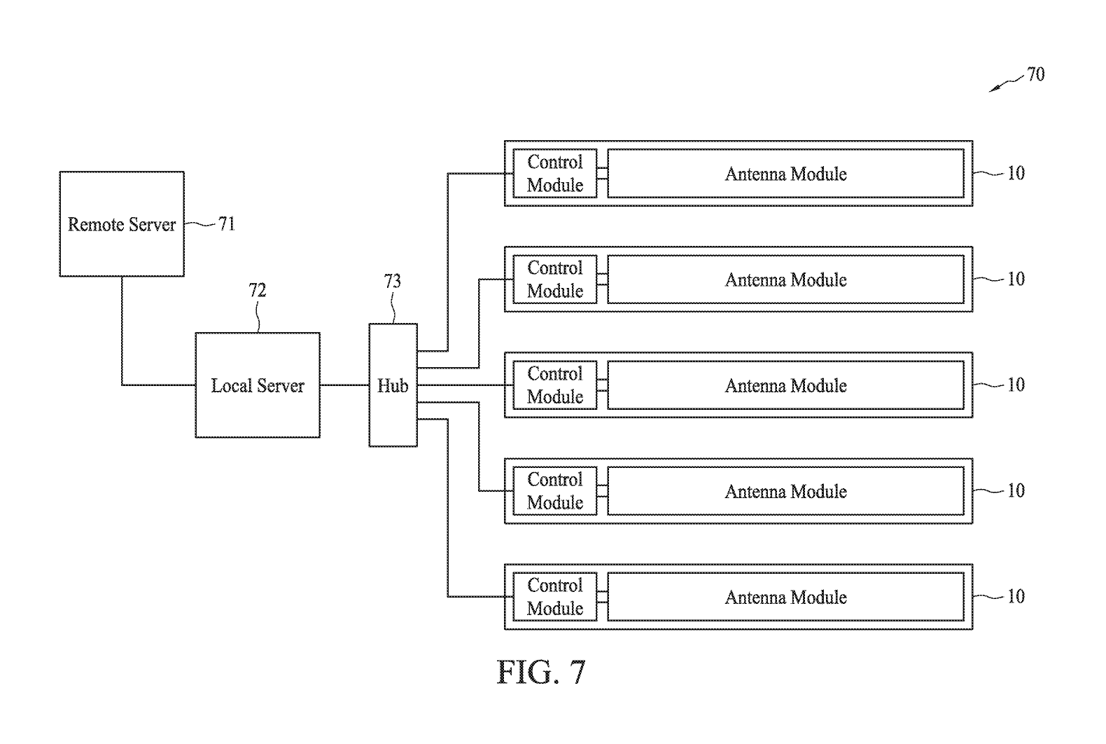

FIG. 7 is a diagram of a multi-reader system 70 including a plurality of RFID readers 10, in accordance with some embodiments.

Referring to FIG. 7, the multi-reader system 70 includes a remote server 71, a local server 72, a hub 73 in addition to the RFID readers 10. The RFID readers 10, which may be arranged in an array, increase detection capacity and enhance reading throughput. The RFID readers 10 are connected through the hub 73 to the local server 72 which controls the multiple RFID readers 10. The remote server 71, which may be a cloud server, controls one or more local servers 72. In an embodiment, the RFID readers 10 are connected to the hub 73 via cables, and the local server 72 is wirelessly connected to the remote server 71. The multi-reader system 70 facilitates inventory management.

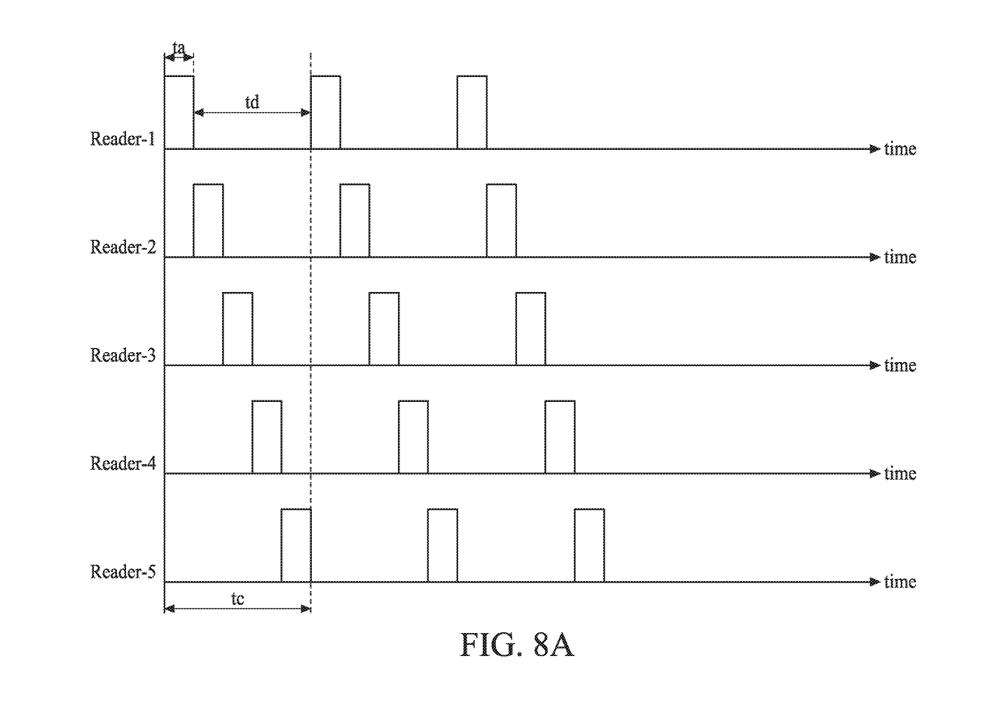

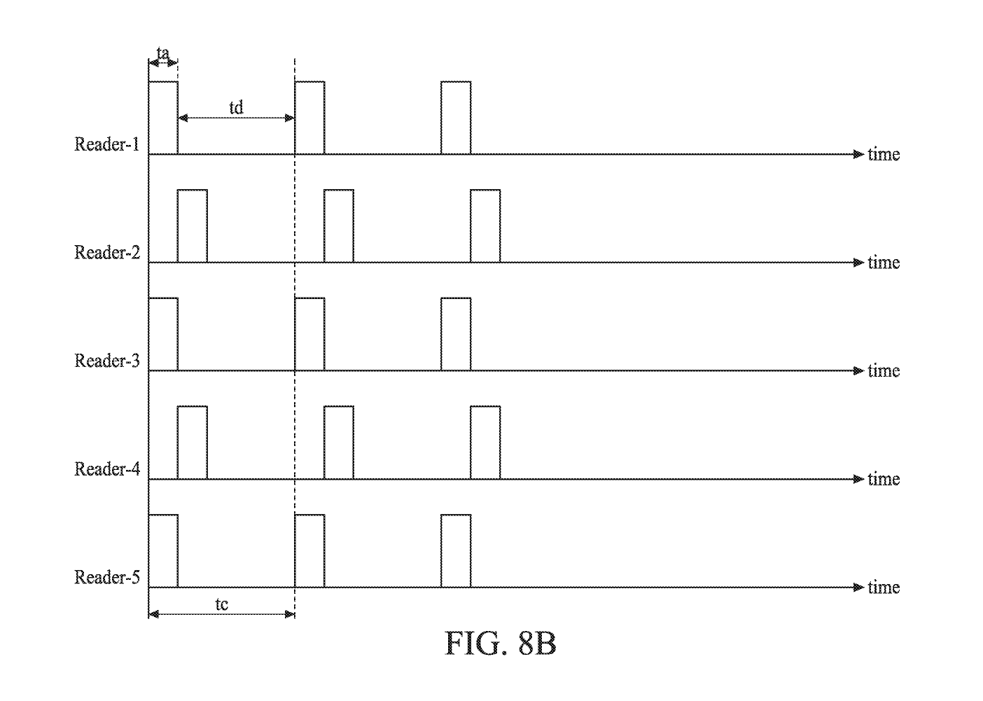

FIG. 8A is a schematic diagram of a sequential scheduling mechanism for the multi-reader system 70 illustrated in FIG. 7, in accordance with some embodiments.

Referring to FIG. 8A, each of the RFID readers 10 may be averagely allocated an active period ta in an operating cycle tc, and is kept idle for td when not active. The active period ta of one RFID reader 10 does not overlap with that of another RFID reader 10. As a result, only one of the RFID readers 10 is active at a certain time point during an operating cycle tc.

FIG. 8B is a schematic diagram of a parallel scheduling mechanism for the multi-reader system 70 illustrated in FIG. 7, in accordance with some embodiments.

Referring to FIG. 8B, given the same active period ta and idle time td in the operating cycle tc, the active periods ta of some RFID readers 10 overlap with each other. As a result, more than one of the RFID readers 10 are active at a certain time point during an operating cycle tc.

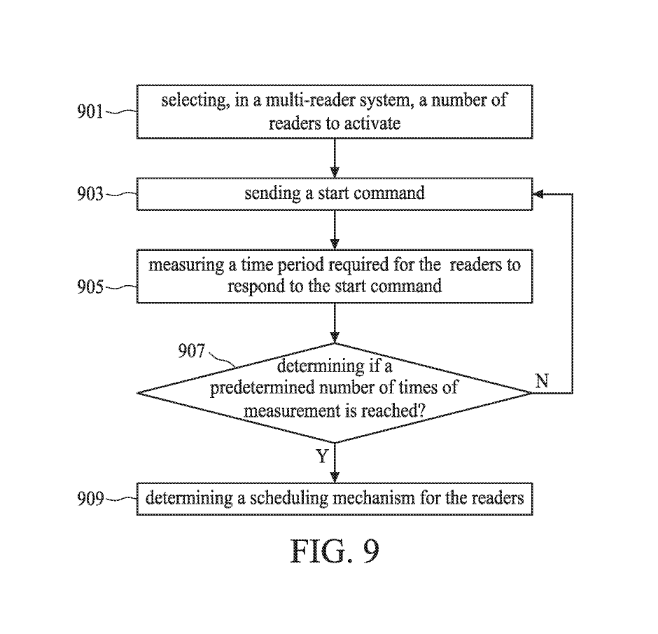

FIG. 9 is a flow diagram showing a method of determining a scheduling mechanism for the multi-reader system 70 illustrated in FIG. 7, in accordance with some embodiments.

Referring to FIG. 9, in operation 901, a number of RFID readers in a multi-reader system is selected. The selected RFID readers are activated in operation 903 in response to a start command from, for example, a remote server or a local server. Next, in operation 905, a time period for the RFID readers to respond to the start command is measured. To ensure a reliable result, the measurement may be repeated for a predetermined number of times in operation 907 until a scheduling mechanism, either sequential or parallel, for the RFID readers is determined in operation 909.

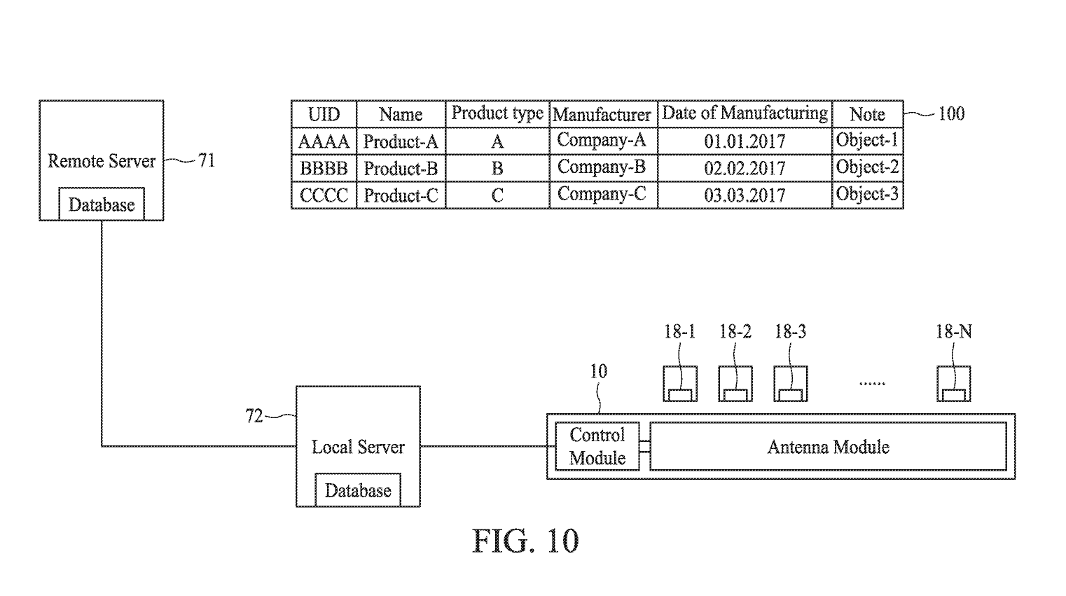

FIGS. 10 to 12 are diagrams showing methods of inventory management in a system that includes one or more RFID readers, in accordance with some embodiments.

Referring to FIG. 10, after scanning tags 18-1, 18-2, 18-3 to 18-N, an RFID reader 10 sends a report on UIDs and object-related information of the tags 18-1, 18-2, 18-3 to 18-N to the local server 72. The local server 72 keeps a database of the UIDs and object-related information from RFID readers coupled to the local server 72. An example database 100 as illustrated includes UIDs, product names, product types, manufacturers and date of manufacturing. In an embodiment, the remote server 71 may also keep a database having a similar structure of the example database 100.

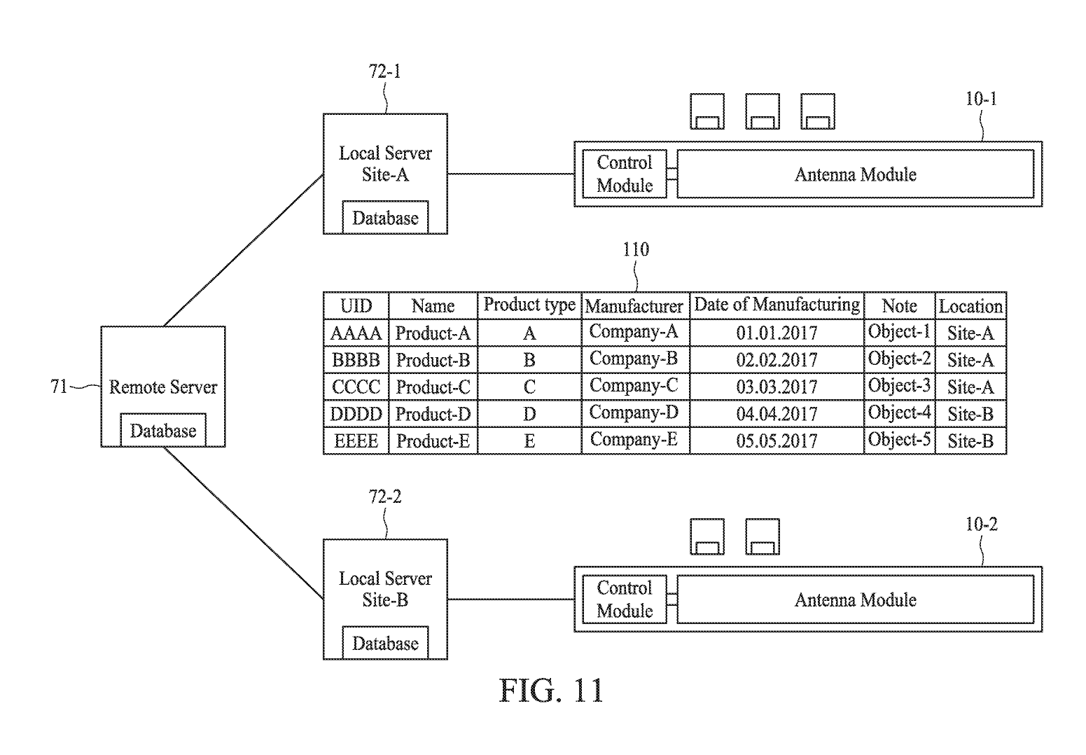

Referring to FIG. 11, a first local server 72-1 and its associated RFID reader 10-1 are disposed at a first site A, while a second local server 72-2 and its associated RFID reader 10-2 are disposed at a second site B. The remote server 71 keeps a database 110 that includes information on UIDs and object-related information collected at the first site A and the second site B.

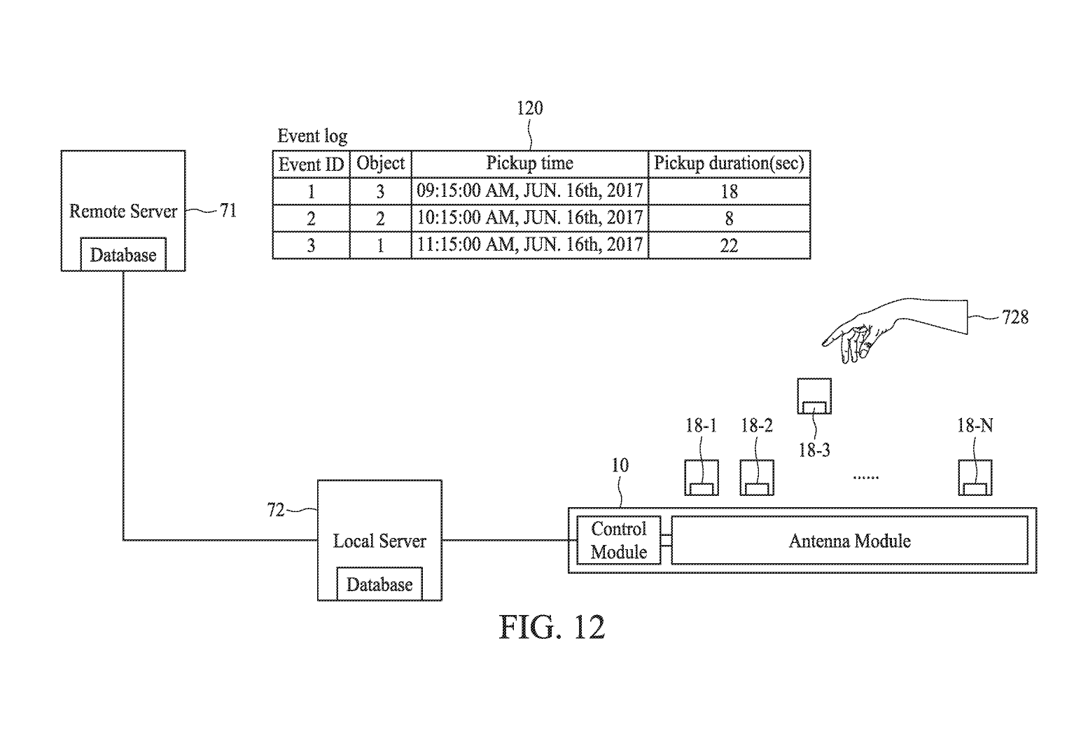

Referring to FIG. 12, the local server 72 may keep a database 120 of pick-up events. In the present embodiment, a potential customer 728 picks up an object 18-3 and views it for 18 seconds. Information on the pick-up event, including the time the object 18-3 is picked up and the duration of the pick-up event, is stored in the database 120. A longer pick-up duration of an object may mean the more interest of the customer 728 in the object.

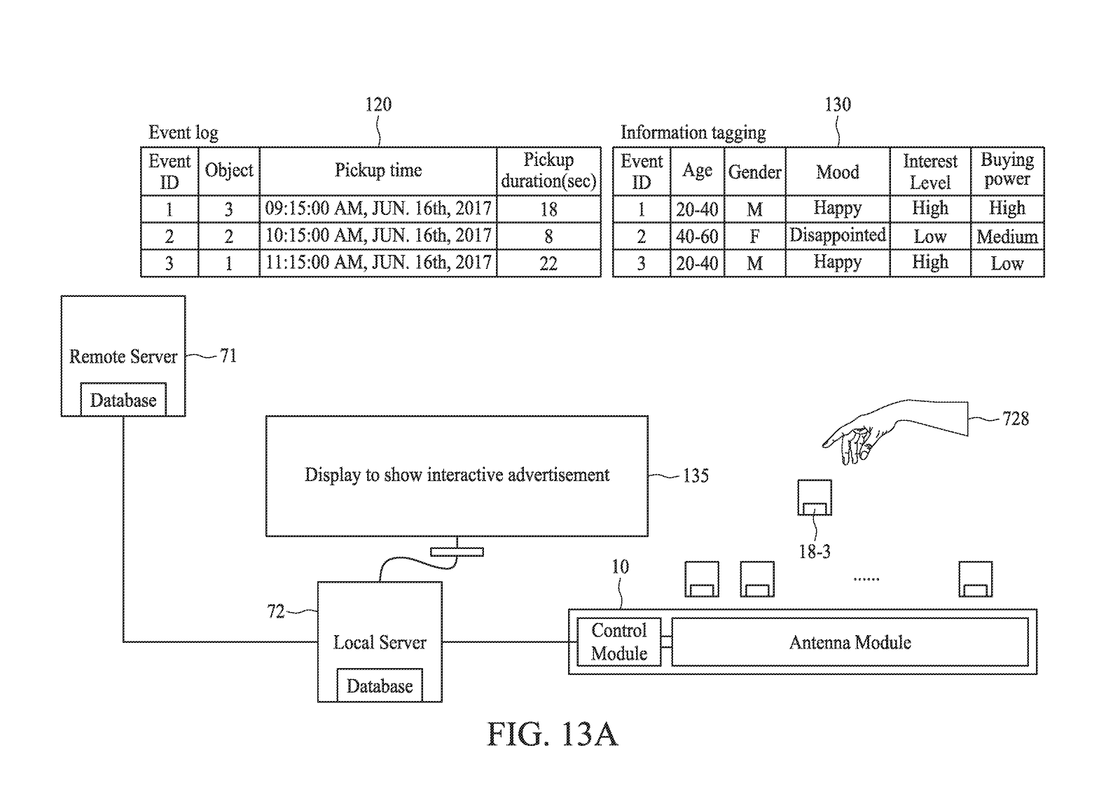

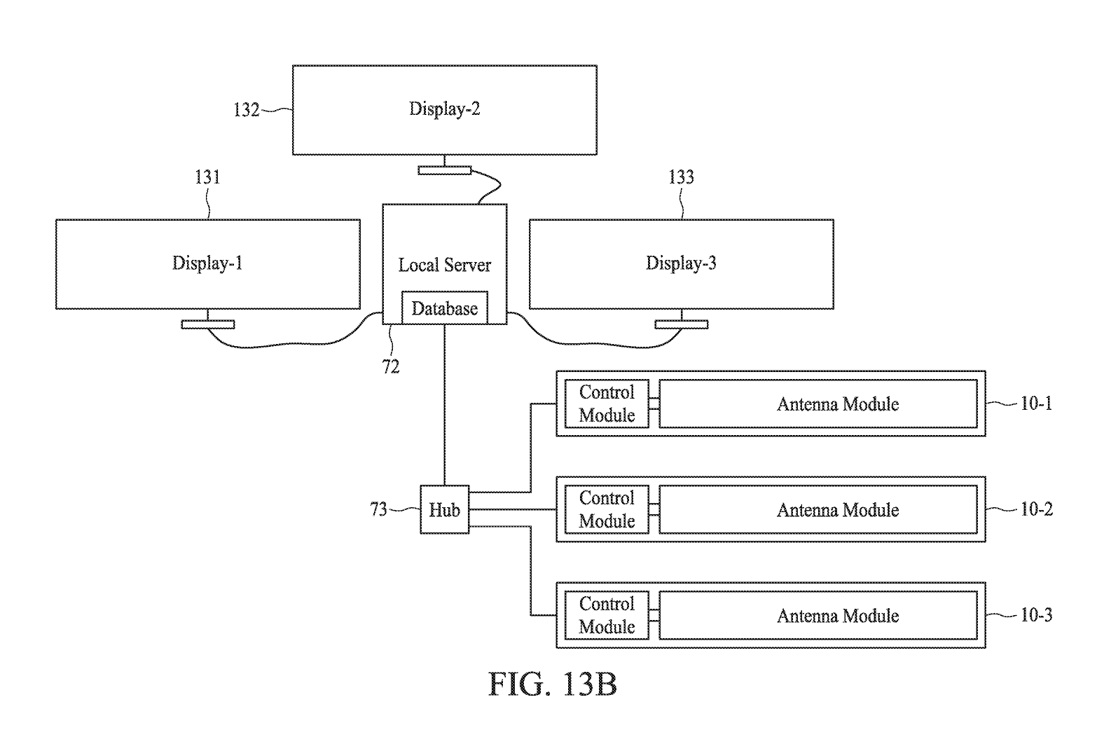

FIGS. 13A and 13B are diagrams of systems for advertisement management based on one or more RFID readers, in accordance with some embodiments.

Referring to FIG. 13A, when an object is picked up, a piece of commercial advertisement associated with the object is played at a display 135 to attract the customer 728. The commercial advertisement may include a multimedia content to encourage a purchase of the object. Attributes of the customer 728 such as age, degree of interest and purchase power may be recorded in a database 130. The database 130 may be used to determine if a commercial advertisement is attractive or effective. This can be for example determined by the number of pick-ups of an object or particular type of objects.

Referring to FIG. 13B, multiple displays 131, 132, and 133 may be employed to support multiple RFID readers 10-1, 10-2, and 10-3 in a multi-reader system.

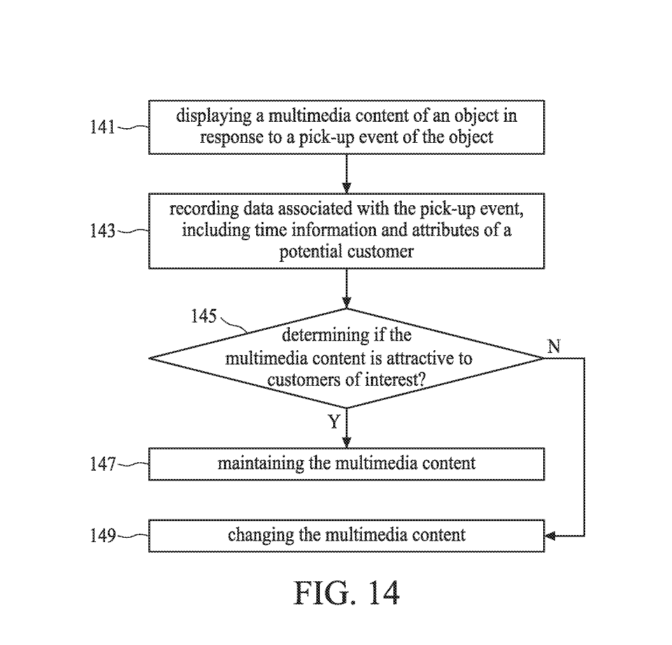

FIG. 14 is a diagram showing a method of advertisement management in a system that includes one or more RFID readers, in accordance with some embodiments.

Referring to FIG. 14, in operation 141, a multimedia content of an object is displayed in response to a pick-up event of the object. Next, in operation 143, data associated with the pick-up event, including time information and attributes of a potential customer are recorded. In operation 145, it is determined if the multimedia content is attractive enough to customers. If affirmative, the multimedia content is maintained in operation 147. If not, the multimedia content will be changed or modified in operation 149.

Although example embodiments have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

What is claimed is:

1. A radio frequency identification (RFID) reader, comprising:
an antenna module configured to scan a plurality of tags, wherein each of the plurality of tags has a unique identifier (UID) and includes information on an object to which the tag is attached; and
a control module configured to activate the antenna module to identify the plurality of tags and, in response to a collision event, send a select command with a select condition to identify a specific tag.

2. The RFID reader according to claim 1, wherein the antenna module is disposed in a board having an oval shape, a circular shape, or a rectangular shape.

3. The RFID reader according to claim 1, wherein the control module is configured to:
activate the antenna module in response to a command from a host; and
send to the host a report including information on the number of tags and UIDs of the tags.

4. The RFID reader according to claim 3, wherein the control module is electrically coupled with the host via a hub.

5. The RFID reader according to claim 1, wherein each of the plurality of tags comprises a memory configured to store object-related information.

6. The RFID reader according to claim 1, wherein the control module is configured to:
generate a first select command with a first select condition to identify a first tag in a collision event, and
generate a second select command with a second select condition to identify a second tag that collides with the first tag in the collision event.

7. The RFID reader according to claim 6, wherein the first select condition and the second select condition include information on a predetermined bit of UIDs of the first tag and the second tag.

8. A multi-reader system, comprising:
a plurality of RFID readers, each of the RFID readers comprising:
an antenna module configured to scan a plurality of tags, wherein each of the plurality of tags has a unique identifier (UID) and includes information on an object to which the tag is attached; and
a control module configured to activate the antenna module to identify the plurality of tags and, in response to a collision event, send a select command with a select condition to identify a specific tag; and
a host, electrically coupled with the plurality of RFID readers, configured to activate at least one of the RFID readers and store information about objects to which the tags are attached.

9. The multi-reader system according to claim 8, wherein the control module is configured to:
generate a first select command with a first select condition to identify a first tag in a collision event; and
generate a second select command with a second select condition to identify a second tag that collides with the first tag in the collision event.

10. The multi-reader system according to claim 9, wherein the first select condition and the second select condition include information on a predetermined bit of UIDs of the first tag and the second tag.

11. The multi-reader system according to claim 8, wherein the host comprises a database that stores information on at least one of a duration time of a pick-up event and attributes of a customer associated with a pick-up event.

12. The multi-reader system according to claim 11 further comprising:
a display, electrically coupled with the host, configured to play commercial material associated with an object in response to a pickup event of the object.

13. The multi-reader system according to claim 12, wherein the host is configured to determine whether the commercial material is attractive based on the information in the database.

14. The multi-reader system according to claim 8, wherein the host is configured to activate the plurality of RFID readers in a sequential order.

15. The multi-reader system according to claim 8, wherein the host is configured to activate the plurality of RFID readers in parallel.

16. A method of anti-collision of tags, the method comprising:
activating a plurality of tags;
obtaining unique identifiers (UIDs) of the plurality of tags;
identifying that a collision event between a first tag and a second tag of the plurality of tags has occurred;
sending a first select command with a first select condition to identify the first tag; and
sending a second select command with a second select condition to identify the second tag.

17. The method according to claim 16, wherein the first select condition and the second select condition include information on a predetermined bit of the UIDs of the first tag and the second tag.

18. The method according to claim 16, wherein each of the plurality of tags includes information on an object to which the tag is attached.

19. The method according to claim 16, wherein each of plurality of tags comprises a memory configured to store object-related information.

20. The method according to claim 16, further comprising:
generating the first select command; and
generating the second select command.
